(19) United States
(12) Patent Application Publication
(10) Pub. No.: US 2023/0098137 A1
(43) Pub. Date: Mar. 30, 2023

(54) METHOD AND APPARATUS FOR REDACTING SENSITIVE INFORMATION FROM AUDIO

(71) Applicant: C/o Uniphore Technologies Inc., Palo Alto, CA (US)

(72) Inventors: Patrick EHLEN, Palo Alto, CA (US); Victor BARRES, Palo Alto, CA (US)

(21) Appl. No.: 17/491,511

(22) Filed: Sep. 30, 2021

(51) Int. Cl. G06F 21/62; G10L 21/00; G06F 40/284; G06F 40/205; G10L 15/26; G06N 20/20

(52) U.S. Cl. CPC G06F 21/62; G10L 21/00; G06F 40/284; G06F 40/205; G10L 15/26; G06N 20/20

(57) ABSTRACT

A method and apparatus for redacting sensitive information from audio is provided. The method comprises identifying, using a plurality of Classifiers, each corresponding to a plurality of sensitive items, a sensitive item (SI) token from a plurality of tokens comprised in a transcribed text of an audio. The SI token corresponds to one of the plurality of sensitive items, each of the plurality of tokens is a transcription of a spoken word in the audio, and each of the plurality of tokens is associated with a corresponding timestamp indicating a chronologic position of the spoken word in the audio. A redaction timespan is determined for the SI token from a first timestamp for the SI token and a second timestamp for a non-SI token immediately after the SI token, and the audio for the redaction timespan is redacted.

### FIELD

The present invention relates generally to speech audio processing, and particularly to redacting sensitive information from audio.

### BACKGROUND

Several businesses need to provide support to its customers, which is provided by a customer care call center. Customers place a call to the call center, where customer service agents address and resolve customer issues, to satisfy the customer's queries, requests, issues and the like. The agent uses a computerized call management system used for managing and processing calls between the agent and the customer. The agent attempts to understand the customer's issues, provide appropriate resolution, and achieve customer satisfaction. Frequently, audio of the call is stored by the system for the record, quality assurance, or further processing, such as call analytics, among others.

During the call, the customer may provide personal and/or sensitive information pertinent to the customer issue, and in several instances, it may be desirable to obfuscate such sensitive information.

Accordingly, there exists a need for methods and apparatus redacting sensitive information from audio.

### SUMMARY

The present invention provides a method and an apparatus for redacting sensitive information from audio, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram depicting an apparatus for redacting sensitive information from audio, in accordance with an embodiment of the present invention.

FIG. 2 is a flow diagram of a method for generating and training classifiers for identifying sensitive information in a transcript of an audio, for example, as performed by the apparatus of FIG. 1, in accordance with an embodiment of the present invention.

FIG. 3 is a flow diagram of a method for preparing training data for training one or more classifiers, for example, the training steps of FIG. 2, in accordance with an embodiment of the present invention.

FIG. 4 is a flow diagram of a method for redacting sensitive information from audio, for example, as performed by the apparatus of FIG. 1, in accordance with an embodiment of the present invention.

FIG. 5 is a schematic representation of the operation of a method for redacting sensitive information from an audio, for example, the method of FIG. 4, in accordance with an embodiment of the present invention.

### DETAILED DESCRIPTION

Embodiments of the present invention relate to a method and an apparatus for redacting sensitive information from audio, for example, an audio of a voice call between an agent and a customer of a business, or an audio of any other dialogue or monologue containing speech. Sensitive information includes information relating to instances of different types of sensitive items, non-limiting examples of which types include credit card numbers, social security numbers, passcodes, home address, account numbers, security questions and/or answers, among several others. Transcripts of an audio are provided as an input into a Sensitive item identifier module (SIIM) comprising multiple Classifiers, each Classifier associated with one sensitive item type, and configured to identify tokens or words of that sensitive item type from the transcript. Each Classifier identifies SI tokens in the transcript corresponding to the sensitive item type the Classifier is associated with. A timespan encompassing the sensitive item (SI) tokens is determined using timestamps associated with the tokens. The audio is modified for the determined timespan(s), redacting the sensitive information therein. The Classifiers of the SIIM are trained using training data which includes training transcripts (of training audios) having tokens timestamped and any SI tokens pre-labeled as a sensitive item. The SI tokens are labeled using a human input or other labeling method as generally known in the art. During the training phase, each of the Classifiers is tested for accuracy, and if a desired accuracy threshold has not been met, the specific Classifier is trained further using similar training data. The training transcripts may be generated automatically using known automatic speech recognition (ASR) techniques or manually, transcribing and timestamping each token, and further, manually identifying and labeling tokens corresponding to a sensitive item.

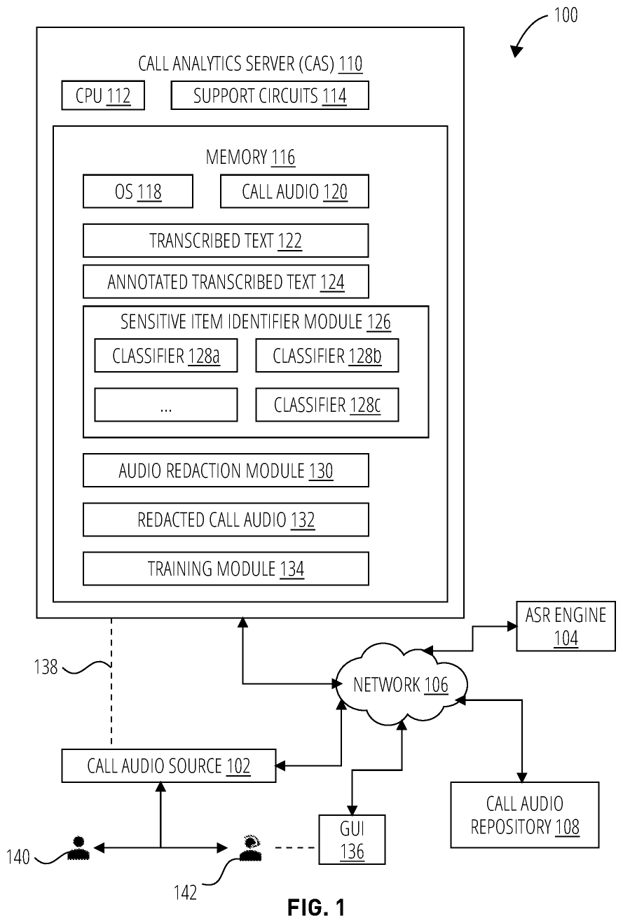

FIG. 1 is a schematic diagram depicting an apparatus 100 for redacting sensitive information from audio, in accordance with an embodiment of the present invention. The apparatus 100 comprises a Call audio source 102, an automatic speech recognition (ASR) engine 104, a Call audio repository 108, and a call analytics server (CAS) 110, each communicably coupled via a Network 106. In some embodiments, the Call audio source 102 is communicably coupled to the CAS 110 directly via a direct link 138, separate from the Network 106, and may or may not be communicably coupled to the Network 106.

The Call audio source 102 provides audio of a call to the CAS 110. In some embodiments, the Call audio source 102 is a call center providing live or recorded audio of an ongoing call between a call center agent 142 and a customer 140 of a business which the call center agent 142 serves. In some embodiments, the call center agent 142 interacts with a graphical user interface (GUI) 136 for providing inputs. In some embodiments, the GUI 136 is capable of displaying an output, for example, transcribed text, to the agent 142, and receiving one or more inputs on the transcribed text, from the agent 142. In some embodiments, the GUI 136 is a part of the Call audio source 102, and in some embodiments, the GUI 136 is communicably coupled to the CAS 110 via the Network 106.

The ASR Engine 104 is any of the several commercially available or otherwise well-known ASR Engines, as generally known in the art, providing ASR as a service from a cloud-based server, a proprietary ASR Engine, or an ASR Engine which can be developed using known techniques. ASR Engines are capable of transcribing speech data (spoken words) to corresponding text data (text words or tokens) using automatic speech recognition (ASR) techniques, as generally known in the art, and include a timestamp for some or each token(s). In some embodiments, the ASR Engine 104 is implemented on the CAS 110 or is co-located with the CAS 110.

The Network 106 is a communication Network, such as any of the several communication Networks known in the art, and for example a packet data switching Network such as the Internet, a proprietary Network, a wireless GSM Network, among others. The Network 106 is capable of communicating data to and from the Call audio source 102 (if connected), the ASR Engine 104, the Call audio repository 108, the CAS 110 and the GUI 136.

In some embodiments, the Call audio repository 108 includes recorded audios of calls between a customer and an agent, for example, the customer 140 and the agent 142 received from the Call audio source 102. In some embodiments, the Call audio repository 108 includes training audios, such as previously recorded audios between a customer and an agent, or custom-made audios for training Classifiers, or any other audios comprising speech and sensitive information. In some embodiments, the Call audio repository 108 includes audios with redacted sensitive information, for example, as received from the CAS 110. In some embodiments, the Call audio repository 108 is located in the premises of the business associated with the call center.

The CAS 110 includes a CPU 112 communicatively coupled to support circuits 114 and a memory 116. The CPU 112 may be any commercially available processor, microprocessor, microcontroller, and the like. The support circuits 114 comprise well-known circuits that provide functionality to the CPU 112, such as, a user interface, clock circuits, Network communications, cache, power supplies, I/O circuits, and the like. The memory 116 is any form of digital storage used for storing data and executable software. Such memory includes, but is not limited to, random access memory, read only memory, disk storage, optical storage, and the like. The memory 116 includes computer readable instructions corresponding to an operating system (OS) 118, a call audio 120, for example, audio of a call between a customer and an agent received from the Call audio source 102 or the Call audio repository 108, transcribed text 122 or transcript 122, Annotated transcribed text 124 or annotated transcript 124, a Sensitive item identifier module (SIIM) 124, an Audio redaction module 130, Redacted call audio 132, and a Training module 130.

The transcribed text 122 is generated by the ASR Engine 104 from the call audio 120. In some embodiments, the call audio 120 is transcribed in real-time, that is, as the conversation is taking place between the customer 140 and the agent 142. In some embodiments, the call audio 120 is transcribed turn-by-turn, according to the flow of the conversation between the agent 142 and the customer 140. In some embodiments, the transcribed text 122 is generated by manual transcription. The transcribed text 122 comprises words or tokens corresponding to the spoken words in the call audio 120, and a timestamp associated with some or all tokens. The timestamps indicate the time in the call audio 120, at which a particular word corresponding to the token was uttered, or began to be uttered.

The Annotated transcribed text 124 or the annotated transcript 124 comprises labels associated with one or more tokens of the transcribed text 122 that contain sensitive items. Chronologic position (or timestamps) of tokens containing sensitive items are annotated as SI tokens. The labels identifying SI tokens are SI labels, and include the timestamp, the sensitive item, that is, whether the SI token is part or all of a credit card number, a social security number, and the like. In some embodiments, the SI labels are generated in BILOU format, where the acronym letters stand for B—‘beginning’, I—‘inside’, L—‘last’, O—‘outside’ and U—‘unit’, and in some embodiments, formats other than BILOU format may be used, such as BIO or a binary indicator label.

The SIIM 126 is configured to identify SI tokens in a given text, for example, the transcribed text 122. The SIIM 126 includes one or more Classifiers 128a, 128b, . . . 128c, each Classifier corresponding to one sensitive item type, and configured to identify SI tokens containing the corresponding sensitive item type. For example, the Classifier 128a is configured to identify and label credit card numbers, the Classifier 128 is configured to identify and label social security numbers, the Classifier 129 is configured to identify and label home address, among others. In some embodiments, the SIIM 126 receives the transcribed text 122 as an input, and generates the Annotated transcribed text 124 as an output, including the SI labels for tokens containing sensitive items (SI tokens). Each Classifier (128a, 128b, . . . 128c) of the SIIM 126 generates an SI label for token(s) in the transcribed text 122 containing the corresponding sensitive item, and all SI labels generated by all Classifiers are aggregated by the SIIM 126 to generate the Annotated transcribed text 124. In some embodiments, the SI labels are generated in a predefined format, such as the BILOU format.

In some embodiments, Classifiers include algorithm(s) configured to map an input data to a category from predefined categories, and include either machine learning (ML) modules that predict labels by statistical means, as known in the art, or by deterministic methods such as a finite state machine. Non-limiting examples of such statistical Classifiers include naive Bayes, decision tree, logistic regression, artificial neural Networks (ANN), support vector machine, Random Forest, Bagging, AdaBoost, or any combination(s) thereof. In some embodiments, Classifier(s) built using known techniques are used.

The Audio redaction module 130 is configured to receive transcribed text with SI tokens annotated with SI labels, for example, the Annotated transcribed text 124 generated by the SIIM 126, and redact call audio, for example, the call audio 120, based on the Annotated transcribed text 124, to generate a Redacted call audio, for example, the Redacted call audio 132. The Audio redaction module 130 determines a redaction timespan based on the SI labels of the SI tokens in the Annotated transcribed text 124. The redaction timespan is a time interval between the beginning of the first SI token (first timestamp) and the beginning of the first following non-SI token, that is, a token which is not part of the sensitive item (second timestamp). If multiple SI tokens are adjacent or next to each other, the first timestamp corresponds to the first SI token among the multiple, adjacent SI tokens, and the second timestamp corresponds to a non-SI token after all such multiple, adjacent SI tokens. Since each token has an associated timestamp, and SI labels identify all SI tokens, the first and second timestamps are readily available, and the redaction timespan is defined as the time interval between the first timestamp and the second timestamp, starting at the first timestamp.

The Audio redaction module 130 may determine one or more redaction timespans, and redacts the call audio 120 for each of the determined redaction timespans, generating the Redacted call audio 132. For example, if an audio of 180 seconds includes first redaction timespan of 10 seconds starting at 45 second, and a second redaction timespan of 15 seconds starting at 120 seconds, then the audio between 45 seconds to 54 seconds and between 120 seconds and 129 seconds is redacted. Redaction may include reducing the amplitude of the audio to zero, or replacing the audio waveform with a tone (e.g., sine wave indicator, or another indicator) or another audio. In some embodiments, the Redacted call audio 132 generated in the manner described above may be stored in the Call audio repository 108.

The Training module 134 is configured to generate and train the Classifiers 128a, 128b, . . . 128c of the SIIM 126 using training data including training audios, and training transcripts for each of the training audios. In some embodiments, the Training module 134 receives an input of the sensitive items for which classifiers need to be generated, and in response, the Training module 134 establishes various classifiers, for example, from the various type of classifiers as discussed above, for each sensitive item type. In some embodiments, the Training module 134 selects an optimal type of classifier depending on the sensitive item type. For example, one type of classifier may be more suited for classifying numerical information (e.g., a credit card number), while another type of classifier may be more suited for classifying strings such as an address or a mother's maiden name. In some embodiments, the Training module 134 receives an input for the type of classifier for each of the sensitive items. Once generated, the Training module 134 further processed the classifiers for training and deployment.

In some embodiments, the training transcripts are generated from the training audios by the ASR Engine 104, and in some embodiments, the training transcripts are transcribed manually from the training audios. The training transcripts include training tokens corresponding to speech in the training audios. The training transcripts are further annotated to include SI labels identifying training tokens having sensitive items. In some embodiments, the training transcripts are annotated with SI labels using human input. For example, a human annotator manually reviews the training transcript(s) and annotates training tokens having sensitive items as SI training tokens. In some embodiments, the human annotator may use a graphical user interface (GUI) to review the training transcript(s) and annotate the SI training tokens. In some embodiments, the human annotator is the agent 142, who uses the GUI 136 to annotate the training transcript(s) identifying the SI training tokens. Other embodiments may include but are not limited to semi-supervised labeling methods such as active learning and data programming, as generally known in the art. The Training module 134 is configured to receive the annotation as an input, and generate SI labels in a predefined format, for example, the BILOU format, and associate the SI labels with the SI training tokens. The training transcript(s) so generated includes the training tokens, and SI labels associated with SI training tokens.

The Training module 134 trains each Classifier (128a, 128b, . . . 128c) individually using the corresponding SI training tokens, identified by SI labels, from the training transcript(s). For example, the Training module 134 trains the Classifier 128a for credit card numbers using the SI training tokens containing a credit card number, the Classifier 128b for social security numbers using the SI training tokens containing a social security number, and so on.

In some embodiments, the Training module 134 determines an accuracy of each Classifier (128a, 128b, . . . 128c) using standard train/test split methodology, as known in the art, where a portion of the labeled data is assigned to a training set, and another portion is held out as a test set to be used for evaluation. If the determined accuracy of a given Classifier is below a predefined threshold, then the Training module 134 trains the Classifier further, using additional training data, that is, training audios and corresponding training transcripts, until the predefined threshold of accuracy is achieved for the Classifier. In some embodiments, the predefined threshold of accuracy can vary depending on the sensitivity of the redacted item and the desired trade-off between false positive and false negative items retrieved. A security pin is 1234, but it could be a zip code or similar. Once each Classifier (128a, 128b, . . . 128c) has been trained to achieve an accuracy above the predefined threshold, the Training module 134 designates the Classifier as trained, and deploys the trained Classifier to the SIIM 126.

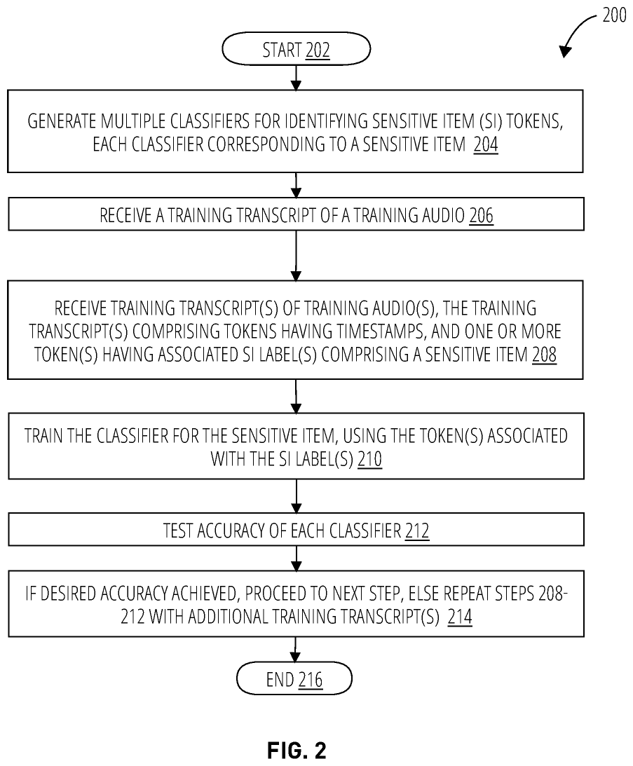

FIG. 2 is a flow diagram of a method 200 for generating and training classifiers for identifying sensitive information in a transcript of an audio, for example, as performed by the apparatus 100 of FIG. 1, in accordance with an embodiment of the present invention. In some embodiments, the Training module 134 of the apparatus 100 performs the method 200. The method 200 begins at step 202, and proceeds to step 204, at which the method 200 generates or establishes multiple classifiers, each corresponding to a sensitive item, for identifying tokens in a transcript containing corresponding sensitive items. For example, the Training module 134 generates a separate classifier for each sensitive item, for example, Classifiers 128a, 128b, . . . 128c. In some embodiments, the Training module 134 is provided a list of sensitive items for which a classifier needs to be generated. Each of the classifiers include one or more of naive Bayes, decision tree, logistic regression, artificial neural Networks (ANN), support vector machine, Random Forest, Bagging, AdaBoost, or a custom-made ML or finite state classifier. In some embodiments, the step 204 is optional, and in such embodiments, a classifier corresponding to each sensitive item is provided in the SIIM 126.

The method 200 proceeds to step 206, at which the method 200 receives training data including training transcripts corresponding to training audios. The training transcripts include training tokens, which for some languages are a transcription of a spoken word in the training audio, and each training token is associated with a timestamp indicating the position of the spoken word in the training audio. The training audio is similar to the call audio or custom made for training, and includes spoken words, some of which include sensitive items. The training transcripts may be generated by the ASR Engine 104, or manually. Tokens in the training transcript having sensitive items are labeled with an SI label to indicate that the tokens have a sensitive item. In some embodiments, the SI labels are received as a human input or generated based on a human input, such an annotation on one or more tokens. In some embodiments, the human input is received by a human annotator via a graphical user interface (GUI) associated with the CAS 110, for example, from the agent 142 via the GUI 136. In some embodiments, the SI labels are received or generated in BILOU format.

The method 200 proceeds to step 208, at which the method 200 trains each of the classifiers, for example, the classifiers 128a, 128b, . . . 128c, separately, using the training transcripts having training tokens and SI labels, as discussed above. In some embodiments, each of the classifiers 128a, 128b, . . . 128c are configured to receive an input of the SI labels in a predefined format, and for example, the BILOU format. The method 200 proceeds to step 210, at which the method 200 measures the accuracy of each classifier in identifying sensitive items. At step 212, the method 200 compares the measured accuracy of each classifier with a predefined threshold accuracy for that classifier to assess whether a desired accuracy for that classifier has been achieved. If the desired accuracy for a given classifier has been achieved (measured accuracy is equal to or greater than the predefined threshold accuracy), the classifier is considered trained. If the desired accuracy has not been achieved (measured accuracy is lower than the predefined threshold accuracy), the method 200 proceeds to train the classifier further, for example, by repeating steps 206-210 with additional training transcripts. In some embodiments, different classifiers are assigned different predefined accuracy thresholds. For example, a higher threshold accuracy may be desirable for sensitive item such as social security numbers, as compared to a threshold accuracy for sensitive item such as a telephone number. The method 200 iterates steps 206-210 for each classifier till the desired accuracy is achieved at step 212 for each classifier.

The method 200 proceeds to step 214, at which the method 200 ends.

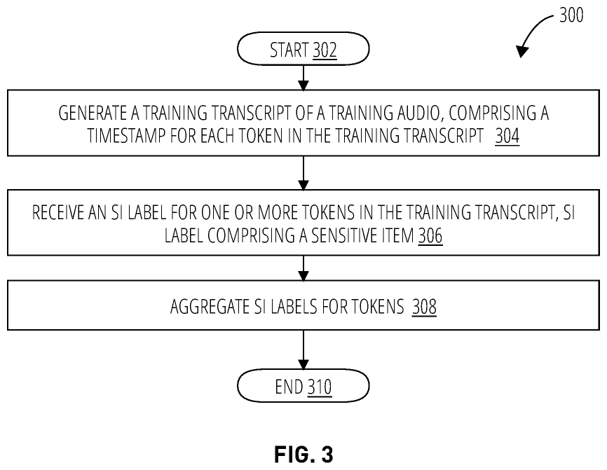

FIG. 3 is a flow diagram of a method 300 for preparing training data for training one or more classifiers, for example, the training steps of FIG. 2, in accordance with an embodiment of the present invention. In some embodiments, the method 300 is performed by the Training module 134. The method 300 begins at step 302, and proceeds to step 304, at which the method 300 generates a training transcript of a training audio. The training transcript comprises a timestamp for each token in the training transcript. The method 300 proceeds to step 306, at which the method 300 receives an input indicating that a token has a sensitive item. In some embodiments, the input is a human input, and is received via a graphical user interface (GUI) communicably coupled with the CAS 110, for example, the GUI 136. For example, the input may contain a highlighting or marking of the tokens having sensitive items. The method 300 proceeds to step 308, at which the method converts the input to a sensitive item (SI) label associated with the token. The method 300 proceeds to step 310 at which the method 300 ends. The method 300 is repeated for all tokens containing sensitive items.

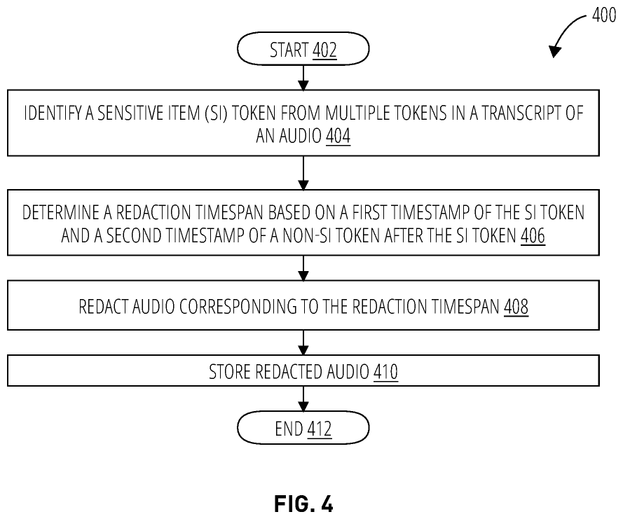

FIG. 4 is a flow diagram of a method 400 for redacting sensitive information from audio, for example, as performed by the apparatus of FIG. 1, in accordance with an embodiment of the present invention. In some embodiments, the method 400 is performed by the Sensitive item identifier module 126. The method 400 begins at step 402, and proceeds to step 404, at which the method 400 identifies at least one sensitive item (SI) token from multiple tokens comprised in a transcribed text of an audio comprising spoken words, for example, in the Transcribed text 122 of the call audio 120, and generates an annotated transcribed text, for example, the Annotated transcribed text 124. In some embodiments, a different classifier (128a, 128b, . . . 128c) identifies tokens that belong to different types of sensitive items. The method 400 proceeds to step 406, at which the method 400 determines, from the Annotated transcribed text 124, a redaction timespan based on a first timestamp of a sensitive item (SI) token and a second timestamp of a non-SI token (token not containing a sensitive item) positioned immediately after the SI token. If one or more SI tokens are positioned immediately after the SI token positioned at the first timestamp, the second timestamp corresponds to the non-SI token positioned immediately after the one or more SI tokens. The method 400 determines the redaction timespan as the time interval starting at the first timestamp and ending at the second timestamp. In some embodiments, more than one redaction timespans are determined, for example, when multiple SI tokens are not adjacent to each other, and have non-SI tokens in between, are present in the Annotated transcribed text 124.

The method 400 proceeds to step 408, at which the method 400 redacts one or more portions of the call audio 120 corresponding to the redaction timespan(s) determined at step 406. Redaction of a portion of an audio includes reducing the amplitude of the audio in the portion to zero, or replacing the audio in the portion with another audio, for example, a sine wave indicator, or other indicator(s). The method 400 proceeds to step 410, at which the method 400 stores the redacted audio, for example, as the Redacted call audio 132. In some embodiments, the Redacted call audio 132 is sent for storage to a remote location on the Network 106, for example, the Call audio repository 108.

The method 400 proceeds to step 412, at which the method 400 ends.

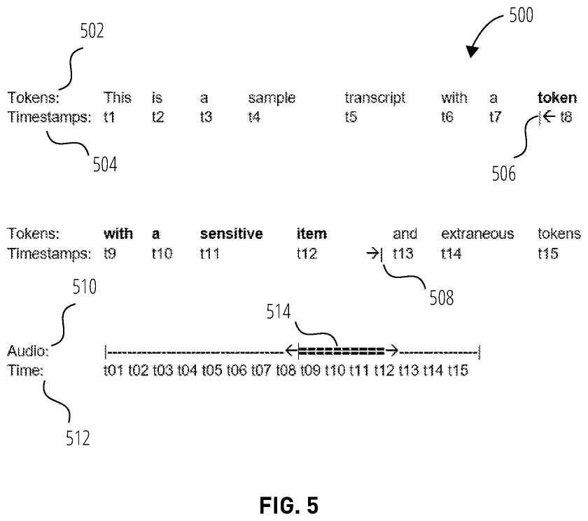

FIG. 5 is a schematic representation 500 illustrating an operation of the method 400 for redacting sensitive information from an audio 512 having a time 514 length, in accordance with an embodiment of the present invention. The tokens 502 or words of a transcribed text corresponding to the audio 512 are shown along with the timestamps 504, t1-t15. The tokens starting at token 506 and ending at token 508, that is the text “token with a sensitive item,” are determined as sensitive item (SI) tokens, for example, according to step 404 of the method 400. Next, a first timestamp t8 is identified corresponding to the SI token 506, and a second timestamp t13 is identified corresponding to the first non-SI token 510 immediately after the SI token 508, where all tokens between the token 506 and 508 are SI tokens, and a redaction timestamp is defined as the time interval t13-t8, starting at t8, for example, according to step 406 of the method 400. Based on the determined redaction timespan, the Sensitive item identifier module 126 redacts a portion 516 of the audio 512, the portion 516 starting at t8 and ending at t13.

While audios have been described with respect to call audios of conversations in a call center environment, the techniques described herein are not limited to such call audios. Those skilled in the art would readily appreciate that such techniques can be applied readily to any audio containing speech, including single party (monologue) or a multi-party speech.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

I/We claim:

1. A method for redacting sensitive information from audio, the method comprising:
identifying, at a call analytics server (CAS), using a plurality of Classifiers, each of the plurality of Classifiers corresponding to a plurality of sensitive items, at least one sensitive item (SI) token from a plurality of tokens comprised in a transcribed text of an audio comprising spoken words,
wherein the at least one SI token corresponds to at least one of the plurality of sensitive items,
wherein each of the plurality of tokens is a transcription of a spoken word or semantic unit in the audio, and
wherein each of the plurality of tokens is associated with a corresponding timestamp indicating a chronologic position of the token in the audio;
determining a redaction timespan for the at least one SI token from a first timestamp of at least one SI token and a second timestamp of a non-SI token immediately after the at least one SI token; and
redacting the audio for the redaction timespan.

2. The method of claim 1, wherein the at least one SI token comprises a plurality of sequential SI tokens, and wherein the second timestamp corresponds to a non-SI token after the plurality of sequential SI tokens.

3. The method of claim 2, wherein at least two of the plurality of sequential SI tokens correspond to at least two of the plurality of sensitive items.

4. The method of claim 1, wherein the redaction timespan is equal to or less than the time interval between the first timestamp and the second timestamp.

5. The method of claim 1, wherein redacting comprises reducing an amplitude of the audio for the redaction timespan to zero, or replacing the audio for the redaction timespan with a replacement audio.

6. The method of claim 1, further comprising storing the redacted audio.

7. The method of claim 1, wherein each of the plurality of Classifiers comprises at least one of naive Bayes, decision tree, logistic regression, artificial neural Networks (ANN), support vector machine, Random Forest, Bagging, or AdaBoost.

8. The method of claim 1, wherein each of the plurality of Classifiers is a machine learning (ML) model, and wherein the plurality of Classifiers are trained using a method comprising:
receiving, at the CAS, the plurality of sensitive items;
receiving, at the CAS, at least one training transcript corresponding to a training audio, the at least one training transcript comprising:
a plurality of training tokens, and
at least one SI label corresponding to at least one training SI token from the plurality of training tokens, the SI label comprising the sensitive item associated with the at least one training SI token, wherein the SI label is a human input; and
training each of the plurality of Classifiers based on the at least one training SI token associated with the corresponding sensitive item.

9. The method of claim 8, wherein the at least one training transcripts comprises a plurality of training transcripts, and wherein the at least one training SI token comprises a plurality of training SI tokens.

10. A computing apparatus comprising:
a processor; and
a memory storing instructions that, when executed by the processor, configure the apparatus to:
identify, at a call analytics server (CAS), using a plurality of Classifiers, each of the plurality of Classifiers corresponding to a plurality of sensitive items, at least one sensitive item (SI) token from a plurality of tokens comprised in a transcribed text of an audio comprising spoken words,
wherein the at least one SI token corresponds to at least one of the plurality of sensitive items,
wherein each of the plurality of tokens is a transcription of a spoken word in the audio, and
wherein each of the plurality of tokens is associated with a corresponding timestamp indicate a chronologic position of the spoken word in the audio;
determine a redaction timespan for the at least one SI token from a first timestamp of the at least one SI token and a second timestamp of a non-SI token immediately after the at least one SI token; and
redact the audio for the redaction timespan.

11. The computing apparatus of claim 10, wherein the at least one SI token comprises a plurality of sequential SI tokens, and wherein the second timestamp corresponds to a non-SI token after the plurality of sequential SI tokens.

12. The computing apparatus of claim 11, wherein at least two of the plurality of sequential SI tokens correspond to at least two of the plurality of sensitive items.

13. The computing apparatus of claim 10, wherein the redaction timespan is equal to or less than the time interval between the first timestamp and the second timestamp.

14. The computing apparatus of claim 10, wherein redacting comprises reducing the audio amplitude for the redaction timespan to zero, or replacing the audio for the redaction timespan with a replacement audio.

15. The computing apparatus of claim 10, wherein the instructions further configure the apparatus to store the redacted audio.

16. The computing apparatus of claim 10, wherein each of the plurality of Classifiers comprises at least one of naive Bayes, decision tree, logistic regression, artificial neural Networks (ANN), support vector machine, Random Forest, Bagging, or AdaBoost.

17. The computing apparatus of claim 10, wherein each of the plurality of Classifiers is a machine learn (ML) model, and wherein the plurality of Classifiers are trained using a method comprising:
receive, at the CAS, the plurality of sensitive items;
receive, at the CAS, at least one training transcript corresponding to a training audio, the at least one training transcript comprising:
a plurality of training tokens, and
at least one SI label corresponding to at least one training SI token from the plurality of training tokens, the SI label comprising the sensitive item associated with the at least one training SI token, wherein the SI label is a human input; and
train each of the plurality of Classifiers based on the at least one training SI token associated with the corresponding sensitive item.

18. The computing apparatus of claim 17, wherein the at least one training transcripts comprises a plurality of training transcripts, and wherein the at least one training SI token comprises a plurality of training SI tokens.

19. A method for generating a machine learning model for identifying sensitive information in an audio, the method comprising:
generating, at a call analytics server (CAS), a plurality of Classifiers corresponding to a plurality of sensitive items, each of the plurality of Classifiers configured to identify tokens associated with the corresponding sensitive item from the plurality of sensitive items;
receiving, at the CAS, at least one training transcript corresponding to a training audio, the at least one training transcript comprising a plurality of training tokens,
wherein each of the plurality of training tokens is a transcription of a spoken word in the training audio,
wherein each of the plurality of training tokens is associated with a corresponding timestamp indicating a chronologic position of the spoken word in the training audio,
wherein at least one of the plurality of training tokens is associated with a SI label comprising a first sensitive item from the plurality of sensitive items, wherein the SI label is a human input; and
training a first Classifier from the plurality of Classifiers, the first Classifier corresponding to the first sensitive item.

20. The method of claim 19, further comprising:
measuring accuracy of a classifier from the plurality of classifiers;
comparing the measured accuracy of the classifier with a predefined threshold accuracy for the classifier;
training the classifier further until the accuracy of the classifier becomes equal to or greater than the predefined threshold accuracy.
